(19) United States
(12) Patent Application Publication
(10) Pub. No.: US 2013/0059225 A1
(43) Pub. Date: Mar. 7, 2013

(54) FUEL CELL COMPRISING A MEMBRANE HAVING LOCALIZED IONIC CONDUCTION AND METHOD FOR MANUFACTURING SAME

(71) Applicants: Vincent Faucheux, Lans en Vercors (FR); Antoine Latour, Grenoble (FR); Jean-Yves Laurent, Domene (FR); Audrey Martinent, Grenoble (FR)

(72) Inventors: Vincent Faucheux, Lans en Vercors (FR); Antoine Latour, Grenoble (FR); Jean-Yves Laurent, Domene (FR); Audrey Martinent, Grenoble (FR)

(73) Assignee: COMMISSARIAT A L'ENERGIE ATOMIQUE ET AUX ENERGIES ALTERNATIVES, Paris (FR)

(21) Appl. No.: 13/640,273

(22) PCT Filed: Mar. 21, 2011
(86) PCT No.: PCT/FR11/00156

§ 371 Date: Nov. 8, 2012

(30) Foreign Application Priority Data
Apr. 7, 2010 (FR) 1001436

(51) Int. Cl. H01M 8/24; B32B 37/12; H01M 8/10

(52) U.S. Cl. 429/465; 429/492; 156/60

(57) ABSTRACT

A fuel cell is provided with an individual cell having first and second electrodes and a membrane formed by a polymer electrolyte including an ionically conducting part. The polymer electrolyte includes at least an ionically non-conducting part forming a first inactive area localized on a first uncovered part not covered by the first electrode and/or a second inactive area localized on a second uncovered part not covered by the second electrode. A cover encloses the cell and is provided with an inner wall mechanically fixed onto at least the first or second inactive area by adhesion means.

### BACKGROUND OF THE INVENTION

The invention relates to a fuel cell having at least one individual cell and a cover provided with an inner wall housing the individual cell. The cell is provided with first and second electrodes and with a membrane formed by a polymer electrolyte comprising an ionically conducting part, said membrane comprising:
a first main surface formed by a first part covered by the first electrode and a first part not covered by the first electrode and,
a second main surface formed by a second part covered by the second electrode and a second part not covered by the second electrode.

The invention also relates to a fabrication method of a fuel cell.

### STATE OF THE ART

The voltage delivered by a unitary fuel cell, i.e. a fuel cell comprising a single individual cell formed by an Electrode-Membrane-Electrode (or EME) assembly with associated current collectors, is not in general sufficient for low/medium power applications. Certain applications liable to use fuel cells as energy source do in fact require high voltages, for example more than a few volts. To increase the voltages, it is necessary to use a fuel cell comprising a plurality of individual cells connected in series, the anode of one individual cell being connected to the cathode of the adjacent cell.

At the present time, an architecture of planar type is privileged for low-power applications of mobile or portable type to the detriment of an architecture of “press-filter” type which is more onerous and unsuitable for integration in this type of device.

The planar architecture consists in juxtaposing several individual cells associated in series with one another in the same plane. Once it has been produced, the planar fuel cell is generally integrated in a cover to enable connection with the fuel. The cover fitted on and generally sealed to the cell is formed by an inert material and ensures tightness of the system.

Recent works have proposed a planar architecture having several individual cells produced from a single membrane.

The document US-A-2004071865 proposes a fuel cell architecture enabling several pairs of electrodes to be associated on the same membrane and the elementary voltage to be artificially increased. The fuel cell is formed by several individual cells separated from one another by vertical insulating layers. Connection between two individual cells is performed by means of a conducting part connecting the anode of one of the individual cells to the cathode of another adjacent individual cell and passing through the membrane between two vertical insulating layers. The connection thus forms a current bushing in the membrane. This architecture is however confronted with problems of gas leaks occurring in particular at the periphery of the cell and due to the presence of the interfaces between the electrochemically active areas and the current bushings. In the course of the operating and shutdown cycle of the cell, the membrane is in fact subjected to an alternation of wetting and drying phases, which leads to a variation of the thickness of the membrane. At the interfaces, these thickness variations lead to large mechanical stresses which contribute to the unsticking of the membrane and to the occurrence of gas leaks. These leaks result in losses of performance but are also potentially dangerous due to the risk of formation of an explosive hydrogen/oxygen mixture. Furthermore, the current bushings in the membrane introduce a weak electronic conductivity, which causes losses of performance and heating of the membrane.

The document DE-A-19624887 also proposes a fuel cell comprising several individual cells. The fuel cell comprises an electrically conducting and ionically non-conducting contact which electrically connects each membrane of the individual cells.

Patent application US-A-20060228605 proposes another fuel cell architecture having an electrolytic membrane formed by impregnation of a fabric with an ionically conducting material. FIGS. 1 and 2 represent such a cell comprising a set of anodes 1 and cathodes 2 on each side of the membrane 3. The fabric is formed by electrically insulating warp fibres 4 and weft fibres 5, alternately, insulating and electrically conducting, thus respectively forming electrically insulating areas 6 and electrically conducting areas 7. A seal 8 is placed at the periphery of the fabric. The electrically conducting areas 7 delineate each individual cell and also perform series connection of the individual cells formed in this way. This solution remedies the problems of fuel leakage at the interfaces between the electrochemically active areas and the electrically conducting areas 7, as the fabric is fully impregnated with ionically conducting material. However, the presence of the fabric within membrane 3 reduces the power density of the fuel cell. Membrane 3 formed in this way does in fact present a minimum thickness to ensure the mechanical resistance of the assembly. This thickness is about 20 micrometres. However, to increase the power densities, the membranes have to present the smallest possible thickness, preferably between 1 and 10 micrometres. Furthermore, the fibres 4 used to form the fabric of electrically insulating areas 7 hamper proton conduction of the electrochemically active areas. Finally, the variations of thickness of the membrane, observed during operation of the fuel cell, can in the long run provoke the unsticking of the seal and cause internal gas leakages to occur. Seal 8 deposited on an electrochemically active area of the membrane is in fact subjected to large mechanical stresses caused by the variation of the volume of the membrane.

Finally, the document EP-A-1220346 describes a fuel cell comprising a plate in the form of an ionically non-conducting weft between two electrodes. The weft plate is partly covered by an ionically conducting polymer electrolyte. A gas-tight seal is placed directly on a non-conducting part at the periphery of the weft plate 10.

### OBJECT OF THE INVENTION

The object of the invention is to provide a fuel cell and a method for manufacturing a fuel cell remedying the shortcomings of the prior art.

More particularly, the object of the invention is to provide a fuel cell able to achieve high voltages and in particular voltages compatible with applications having the purpose of supplying mobile devices, while at the same time being easy to produce and presenting an enhanced mechanical strength and a good tightness. A further object of the invention is to propose a fabrication method that is easy to implement to obtain one such fuel cell.

According to the invention, this object is achieved by a fuel cell and a method for manufacturing one such cell according to the appended claims.

### BRIEF DESCRIPTION OF THE DRAWINGS

Other advantages and features will become more clearly apparent from the following description of particular embodiments of the invention given for non-restrictive example purposes only and represented in the accompanying drawings, in which:

FIGS. 1 and 2 schematically represent a fuel cell according to the prior art, respectively in cross-section and in top view.

FIG. 3 schematically represents a particular embodiment of a fuel cell according to the invention in cross-section.

FIG. 4 schematically represents a cross-section along the line AA of FIG. 3.

FIG. 5 schematically represents another particular embodiment of a fuel cell according to the invention in cross-section.

FIG. 6 schematically represents a cross-section along the line BB of FIG. 5.

FIG. 7 schematically represents another particular embodiment of a fuel cell according to the invention in cross-section.

FIG. 8 schematically represents a cross-section along the line CC of FIG. 7.

FIGS. 9 and 10 schematically represent, in cross-section, different steps of a fabrication method of the fuel cell, according to another particular embodiment.

FIGS. 11 to 15 schematically represent in cross-section, different steps of a fabrication method of the fuel cell, according to another particular embodiment.

FIGS. 16 and 17 schematically represent in cross-section, different steps of a fabrication method of the fuel cell, according to another particular embodiment.

FIG. 18 schematically represents another particular embodiment of a fuel cell according to the invention, in cross-section.

FIGS. 19 and 20 schematically represent, respectively in perspective and in cross-section, an open cover of a fuel cell according to FIG. 18, devoid of individual cells.

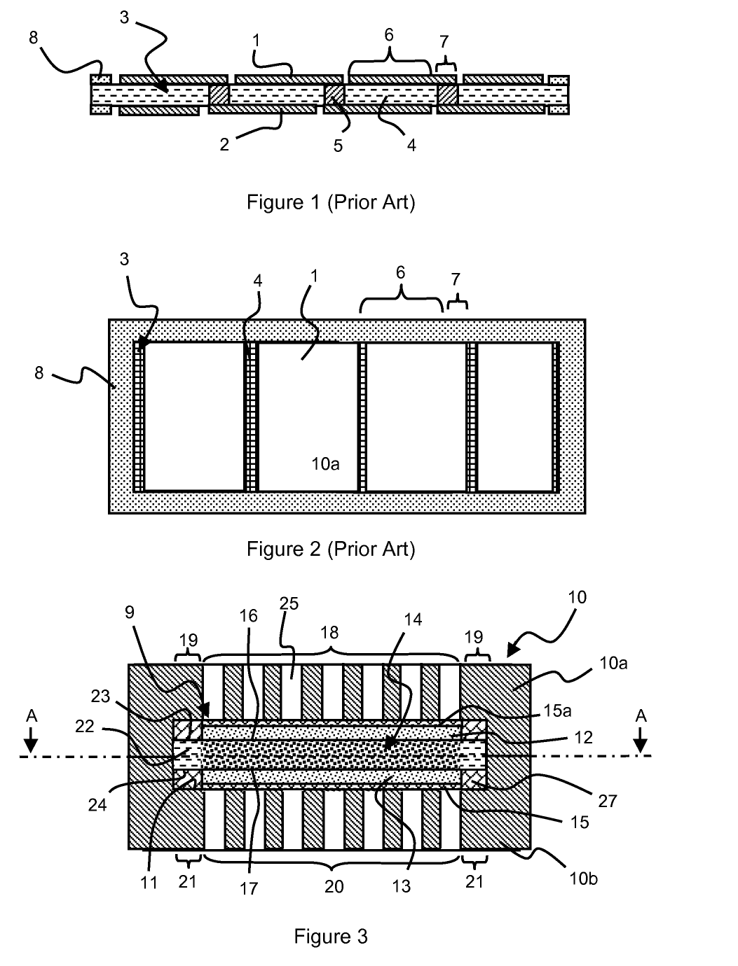

### DESCRIPTION OF PARTICULAR EMBODIMENTS

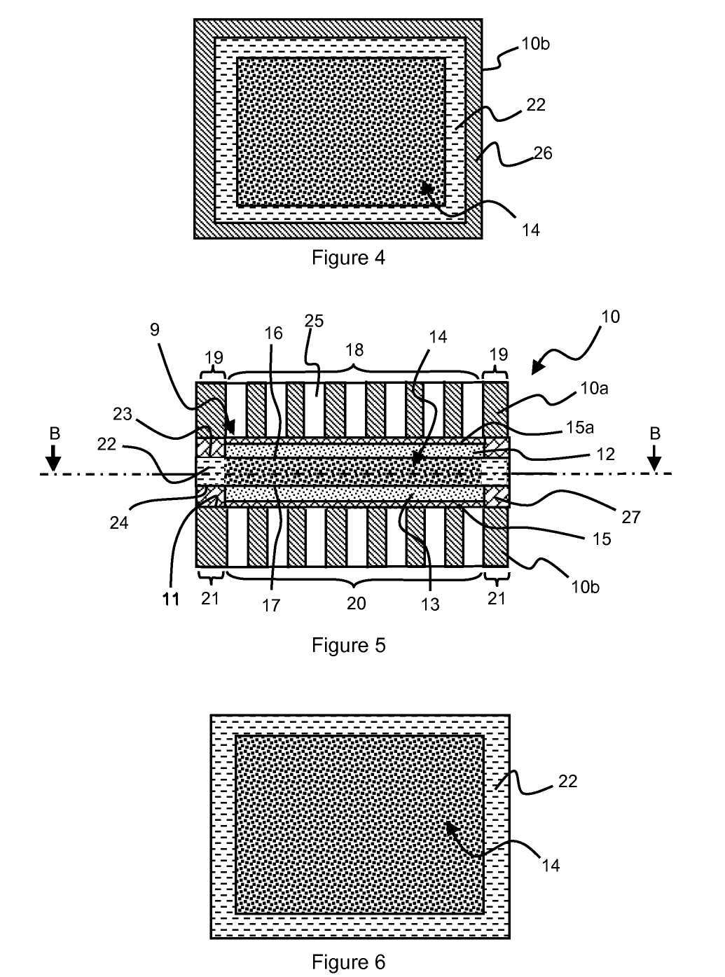

According to a particular embodiment represented in FIGS. 3 and 4, a fuel cell has at least one individual cell 9 and a cover 10 provided with an inner wall 11 enclosing the individual cell 9.

The individual cell 9 is provided with first and second electrodes, respectively 12 and 13, and with a membrane 14 formed by a polymer electrolyte comprising an ionically conducting part.

The individual cell 9 can comprise first and second current collectors 15a and 15b, which respectively cover the first and second electrodes 12 and 13. Each first and second current collector 15a and 15b is conventionally formed by a thin current-conducting porous layer, which is preferably made from metal. First and second current collectors 15a and 15b, are arranged between inner wall 11 and respectively the first and second electrodes 12 and 13.

The first and second current collectors 15a and 15b have a thickness advantageously comprised between 0.1 μm and 100 μm.

The first and second electrodes respectively 12 and 13 have a thickness advantageously comprised between 1 μm and 100 μm.

The first and second electrodes respectively 12 and 13 can also act as current collectors.

The thickness of the membrane 14 is advantageously comprised between 10 μm and 200 μm.

The membrane 14 is arranged between the first and second electrodes, respectively 12 and 13, which are generally permeable to gases, for example porous.

The membrane 14 is formed by a polymer electrolyte comprising at least an ionically conducting part and an ionically non-conducting part 22. The membrane 14 and/or the polymer electrolyte forming said membrane is also electronically non-conducting to avoid any short-circuit in the fuel cell.

The ionically non-conducting part 22 is thus also electronically non-conducting. The ionically non-conducting part 22 presents insulating properties.

The ionically conducting part is also electronically non-conducting. The ionically conducting part presents insulating properties.

According to a particular embodiment represented in FIG. 3, the membrane 14 is formed by a single polymer electrolyte material comprising:
at least one ionically conducting and electronically non-conducting part and,
at least one ionically and electronically non-conducting part 22.

What is meant by single polymer electrolyte material is a material originating from a single initial polymer, modified so as to obtain said ionically conducting and electronically non-conducting part and said ionically and electronically non-conducting part 22.

The polymer electrolyte forming the ionically conducting part and the ionically non-conducting part can advantageously originate from a single and same initial polymer electrolyte. The membrane 14 can thus initially be a proton conducting polymer electrolyte, preferably chosen from polymers having sulfonic acid functions of Nafion® type (trademark registered by Dupont de Nemours).

The membrane 14 comprises a first main surface 16 and a second main surface 17. The first main surface 16 is formed by a first part 18 covered by the first electrode 12 and a first part 19 not covered by the first electrode 12. Likewise, the second main surface 17 is formed by a second part 20 covered by the second electrode 13 and a second part 21 not covered by the second electrode 13.

The polymer electrolyte comprises at least one ionically non-conducting part 22 forming a first inactive area 23 located on the first uncovered part 19 and/or a second inactive area 24 located on the second uncovered part 21.

The ionically non-conducting part 22 is no longer electrochemically active. The capacity of the membrane 14 to absorb water is thereby locally eliminated by forming an ionically non-conducting part 22. This ionically non-conducting part 22 only acts as physical separator between the first electrode 12 and second electrode 13, at the level of localized areas of the membrane 14.

As represented in FIG. 3, the ionically non-conducting part 22 can extend from the first inactive area 23 to the second inactive area 24, over the whole thickness of the membrane 14.

As represented in FIG. 4, the ionically non-conducting part 22 advantageously delineates the individual cell 9. Each first and second inactive area 23 and 24 respectively surrounds the first and second electrodes 12 and 13. The first and second parts, 18 and 20, covered by the first and second electrodes 12 and 13, then correspond to the active surfaces of the individual cell 9.

The cover 10 enables a mechanical strength of the individual cell 9 to be ensured. When the fuel cell is in operation, the cover 10 absorbs the mechanical stresses in particular related to the strains caused by swelling of the membrane 14 and the fuel pressure applied to the membrane 14.

Cover 10 is generally presented in two parts, a first cover 10a and a second cover 10b. The first and second covers, respectively 10a and 10b, are placed on each side of membrane 14 and sealed in such a way that the inner wall 11 of the cover 10 encloses the individual cell 9.

Each first and second cover, respectively 10a and 10b, comprises a wall that is permeable to gases facing each first and second electrode, respectively 12 and 13.

As represented in FIG. 3, each first and second cover 10a and 10b is rendered permeable by means of openings 25 passing through the whole thickness of the cover 10 so as to form passages for the gases supplying first and second electrodes, respectively 12 and 13.

As illustrated in FIG. 4, each first and second cover 10a and 10b can also be provided with a ledge 26 forming a junction of first and second covers 10a and 10b, at the periphery of the cover 10. The first cover 10a is fitted onto second cover 10b so as to completely envelop the individual cell 9.

The cover 10 can also perform connection to a water collection and fuel supply system (not shown).

As represented in FIG. 3, the inner wall 11 is preferably fixed directly onto at least the first and second inactive areas, respectively 23 and 24, of membrane 14, to ensure the tightness of the individual cell 9. The inner wall 11 of the cover 10 is mechanically fixed onto at least the first or second inactive area, respectively 23 and 24, by gas-tight adhesion means 27 filling the space arranged between the inner wall 11 of the cover 10 and the membrane 14. The adhesion means 27 enable the cover 10 to be secured to the individual cell 9.

Thus, the adhesion means 27 being applied on first and second inactive areas, 23 and 24, ionically non-conducting, they are not subjected to the mechanical stresses caused by the variations of thickness of the membrane 14. Locating the adhesion means 27 on the first and second inactive areas, respectively 23 and 24, consequently prevents the adhesion means 27 from unsticking from the membrane 14 and thereby contributes to improving the mechanical strength of the fuel cell.

The adhesion means 27 can advantageously be applied on the periphery of each first and second electrode, 12 and 13, of the individual cell 9.

Furthermore, the adhesion means 27 can advantageously be applied on the whole of the first and second uncovered parts, respectively 19 and 21. The adhesion means 27 then ensure the tightness of the fuel cell.

The adhesion means 27 advantageously comprise an adhesive material, preferably chosen from cements, soldering materials such as metals and metal alloys, adhesive tapes and glues or varnishes having an epoxy, silicone or polyurethane base. What is meant by adhesive tape is a support presenting two surfaces made from adhesive material.

The adhesion means 27 can comprise an electrically conducting material and also constitute electric connection means of the first and second electrodes 12 and 13.

The electrically conducting material is chosen from carbon and metals, preferably gold, silver, copper, nickel, aluminium and their alloys.

The adhesion means 27 can be applied on a part or advantageously on all of the first and second inactive areas, respectively 23 and 24.

Furthermore, according to a preferred embodiment, the first and second inactive areas 23 and 24 respectively form first and second uncovered parts 19 and 21. The first and second inactive areas 23 and 24 are then situated on the periphery respectively of the first and second electrodes 12 and 13, and the adhesion means 27 are applied on the whole of the first and second inactive areas 23 and 24 (FIG. 4).

According to an alternative embodiment represented in FIGS. 5 and 6, the first and second covers 10a and 10b do not possess a ledge 26. The lateral parts of the fuel cell (on the right and on the left in FIG. 5) are not covered by the cover 10. The ionically non-conducting part 22 extends from the first inactive area 23 to the second inactive area 24, over the whole of the thickness of the membrane 14 so that the adhesion means 27 and the ionically non-conducting part 22 ensure the tightness at the level of the lateral parts of the fuel cell.

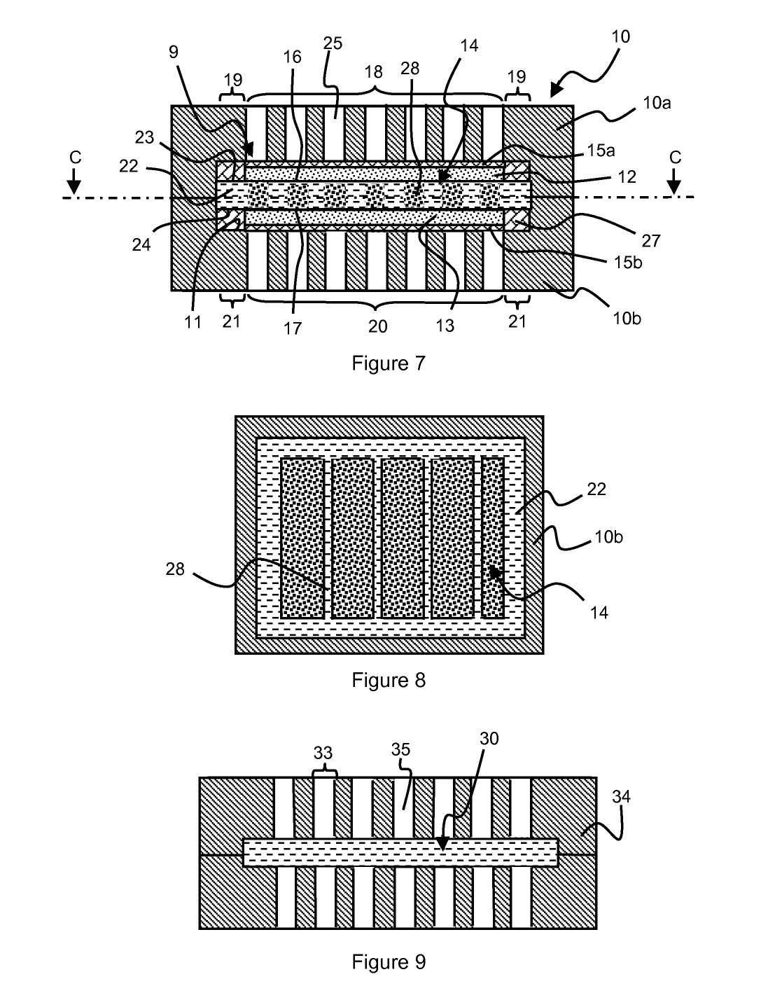

According to a preferred embodiment represented in FIGS. 7 and 8, the fuel cell comprises an additional non-conducting part 28 forming a network of additional inactive areas within the membrane 14.

As represented in FIG. 8, the network can for example form parallel strips on the first and second main surfaces, respectively 16 and 17, of the membrane 14. Alternatively, the network can form a grid in the membrane 14.

As represented in FIG. 7, the additional non-conducting part 28 is located at the level of the first and second covered parts, 18 and 20, of the membrane 14 respectively underneath the first and second electrodes 12 and 13. As for the non-conducting part 22, the additional non-conducting part 28 can be present over the whole thickness of the membrane 14 or only at the level of the first and/or second main surface, respectively 16 and 17. The additional non-conducting part 28 is not subjected to the variations of volume. The presence of the additional non-conducting part 28 reinforces the membrane 14 and enhances the mechanical strength of the fuel cell.

Such a fuel cell is obtained by locally rendering the membrane 14 electro-chemically inactive. In polymer electrolytes of Nafion® type, proton conduction is ensured by the sulfonic acid —SO₃H groups of the polymer chain. The sulfonic acid functions enable migration of the protons through the membrane 14 in H⁺ form but also in a solvated H3O⁺ form. The presence of water molecules then causes swelling of the membrane 14, with a variation that can be of up to 30% with respect to the initial thickness of the membrane 14.

For example purposes, for a thickness of the Nafion® membrane 14 ranging from 10 μm to 200 μm, the variation of thickness can reach an amplitude of 3 μm to 30 μm. By eliminating the —SO₃H functions or rendering them inactive, the swelling of a localized area of the membrane 14 can be avoided.

Two strategies can be envisaged to locally render the membrane 14 electro-chemically inactive. The first consists in forming ionically conducting areas 29 from ionically non-conducting polymer 30 and the second consists in forming ionically non-conducting areas 31 from an ionically conducting polymer 32.

According to a particular embodiment, a fabrication method of such a fuel cell comprises the following steps:
formation of the first and second inactive areas 23 and 24, respectively on the first and second main surfaces 16 and 17 of the membrane 14 formed by an ionically conducting polymer electrolyte and,
fixing of a cover 10 onto the membrane 14 by adhesion means 27 placed between the first inactive area 23 and the inner wall 11 of the cover 10 and/or the second inactive area 24 and the inner wall 11 of the cover 10.

The step of fixing the cover 10 can be performed after or before first and second inactive areas, respectively 23 and 24, are achieved.

According to an alternative embodiment, the two steps of formation and of fixing, described above, can be performed simultaneously.

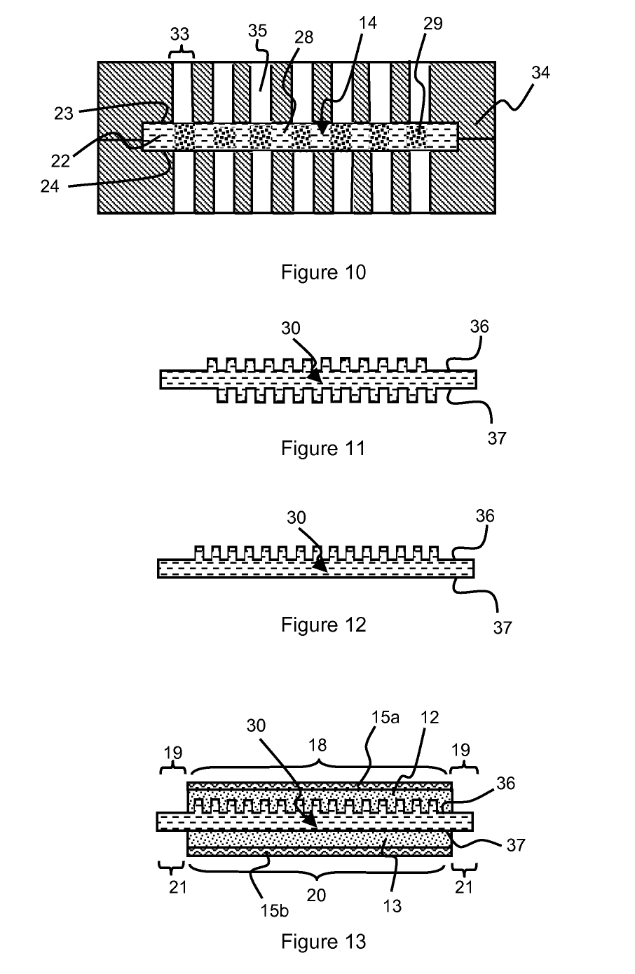

According to a particular embodiment represented in FIGS. 9 and 10, the first and second inactive areas, 23 and 24 can be formed from a membrane 14 initially constituted by an ionically non-conducting polymer 30 having sulfonyl halide functions, preferably sulfonyl fluoride —SO₂F.

The non-conducting polymer 30 can for example be a perfluorinated polymer of Nafion® type, the sulfonic acid functions of which performing transfer of protons into the membrane 14 are neutralized in the form of sulfonyl halide —SO₂F.

The first and second inactive areas, respectively 23 and 24, are achieved by forming ionically conducting areas 29, by hydrolysis of the sulfonyl halide functions of predefined areas 33 of the ionically non-conducting polymer 30. In particular, the —SO₂F functions of the non-conducting polymer 30 are hydrolyzed in —SO₃H sulfonic acid functions which can then perform the conduction and migration of the H⁺ or H₃O⁺ protons in the polymer chains of the membrane 14.

As represented in FIG. 9, prior to fabrication of the individual cell 9, a layer of non-conducting polymer 30 having identical dimensions to those of the membrane 14 is arranged in a press 34 which is provided with drilled holes 35 or is porous according to selected predefined areas 33.

The press 34 along with the polymer layer 30 forms an assembly which is then immersed in a hydrolysis solution.

The holes 35 or pores of the press 34 are made in such a way that the hydrolysis solution can reach the predefined areas 33 of polymer 30.

This hydrolysis solution is chosen from the solutions able to chemically attack the sulfonyl halide functions of polymer 30 and convert them into sulfonic acid functions. The —SO₂F functions are hydrolyzed in sulfonic acid —SO₃H functions, responsible for conduction and migration of the H⁺ or H₃O⁺ protons within the membrane 14.

As represented in FIG. 10, the predefined areas 33 are transformed by hydrolysis into ionically conducting areas 29. This hydrolysis has to take place only on the polymer electrolyte functions responsible for the transfer and conduction of the protons within the membrane 14. This hydrolysis step makes the polymer locally ionically conducting and preserves the ionically non-conducting parts 22 forming the first and second inactive areas 23 and 24 of the membrane 14 and, if applicable, the additional non-conducting parts 28, according to the selected predefined areas 33.

The individual cell 9 can then be produced from the membrane 14 obtained in this way, by means of any known method.

Finally, as before, the cover 10 is fixed to the membrane 14 of the individual cell 9 by adhesion means 27 placed between the first inactive area 23 and the inner wall 11 of the cover 10 and/or the second inactive area 24 and the inner wall 11 of the cover 10.

According to another particular embodiment represented in FIGS. 11 to 15, the fabrication method comprises production of an individual cell 9, by means of any known method, from a membrane 14 initially formed by an ionically non-conducting conducting polymer 30 having —SO₂F functions, preferably a polymer of Nafion® type in —SO₂F form.

The Nafion® non-conducting polymer 30 has the characteristic of being thermo-setting in —SO₃H form and thermoplastic in —SO₂F form. It is thus difficult to form the Nafion® non-conducting polymer 30 in —SO₃H form and easy to do so in —SO₂F form, in particular by conventional thermoforming techniques.

A layer of Nafion® non-conducting polymer 30 in —SO₂F form is used to form a membrane 14 having a geometry in three dimensions, noted 3D geometry.

As represented in FIG. 11, the 3D geometry can be made on the first and second main surfaces, respectively 36 and 37, of a layer of Nafion® non-conducting polymer 30 in SO₂F form.

Alternatively, as represented in FIG. 12, a 3D geometry can be made only on one of the first and second main surfaces 36 and 37 of the Nafion® non-conducting polymer 30 in SO₂F form.

The 3D geometry is preferably made on the surface of the non-conducting polymer 30 designed to be in contact with the cathode of the individual cell 9. Thus, if the first electrode 12 is a cathode, the 3D geometry is advantageously made on the first main surface 36 of the Nafion® non-conducting polymer 30 in SO₂F form.

In particular, as represented in FIG. 13, a layer of Nafion® non-conducting polymer 30 in SO₂F form is deposited and then formed by thermoforming, for example by mechanical pressure in order to print a 3D shape on the first main surface 36 of the polymer 30.

For example purposes, a crenel form can be obtained by thermoforming with a high form factor, greater than 1.2.

An individual cell 9 is then produced by means of any known method from the non-conducting polymer layer 30 shaped in this way. In particular, the first and second electrodes 12 and 13 are conventionally deposited respectively on a part of the first and second main surfaces 36 and 37 of the Nafion® polymer layer 30 in —SO₂F form.

Deposition of the first and second electrodes 12 and 13 respectively form the first and second covered parts 18 and 20, and also the first and second uncovered parts 19 and 21.

The first and second current collectors 15a and 15b are respectively deposited on the first and second electrodes 12 and 13 by means of any known method.

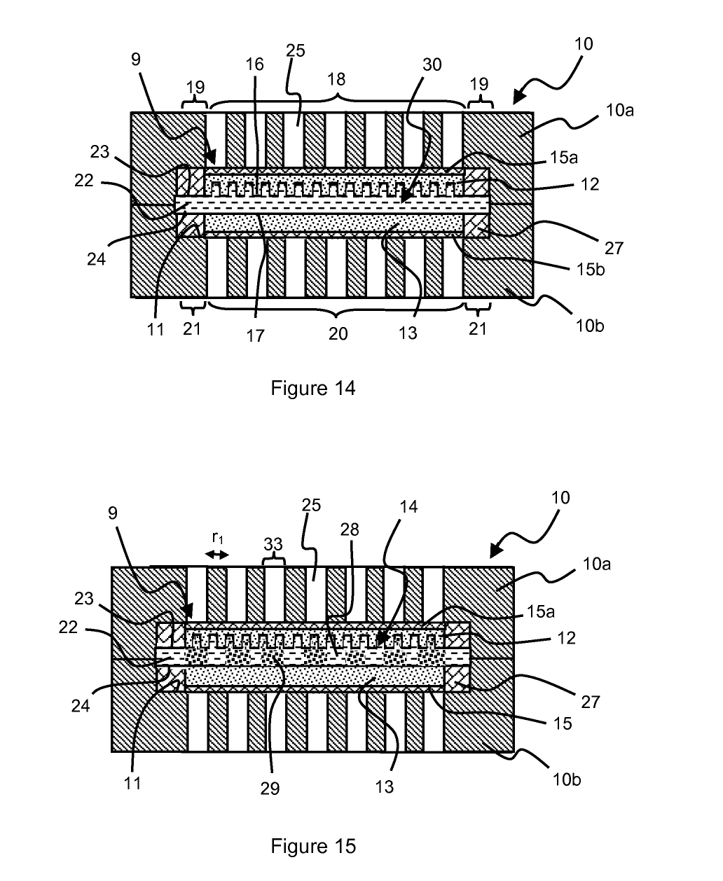

As represented in FIG. 14, the cover 10 is then fixed by means of the adhesion means 27 arranged between the inner wall 11 of the cover 10 and the Nation® non-conducting polymer layer 30 in —SO₂F form so as to delineate the periphery of the first and second electrodes, respectively 12 and 13. The cover 10 and individual cell 9 form a cover/cell assembly.

As represented in FIG. 15, hydrolysis of the —SO₂F functions of the predefined areas 33 of the Nation® non-conducting polymer 30 in —SO₂F form is performed by immersion of the cover/cell assembly in one or more hydrolysis solutions.

For example, the cover/cell assembly is successively immersed in a bath containing a solution of soda, NaOH, followed by sulphuric acid, H₂SO₄. The first and second electrodes 12 and 13 are porous to allow flow of the hydrolysis solution or solutions to the predefined areas 33.

According to this particular embodiment, the cover 10 acts as a press to form the ionically conducting areas 29 from the ionically non-conducting polymer 30. The openings 25 of the cover 10 enable the predefined areas 33 to be made accessible and this hydrolysis step to be controlled so as to obtain a membrane 14 with the required ionic conduction characteristics (FIG. 15).

The resolution r₁ obtained is about 0.1 mm. What is meant by resolution is the smallest dimension r₁ of the pattern formed by the first or second inactive area, respectively 23 and 24, of the membrane 14. This particular embodiment can preferably be applied for an individual cell 9 having an active surface that is larger than or equal to 1 cm².

Furthermore, the configuration of the membrane 14 in three dimensions enables to increase the developed contact surface between the first and second electrodes 12 and 13 and membrane 14, while at the same time keeping the same projected surface. The 3D configuration thereby improves the power density of the fuel cell.

According to another particular embodiment, the membrane 14 is initially formed by an ionically conducting polymer 32 having sulfonic acid —SO₃H functions, for example a Nafion® polymer in —SO₃H form.

The ionically non-conducting parts 22 and 28, and in particular the first and second inactive areas 23 and 24, can be achieved by forming ionically non-conducting areas 31, by degradation of sulfonic acid —SO₃H functions of the predefined areas 33 of the ionically conducting polymer 32.

Degradation of the sulfonic acid —SO₃H functions of the initial ionically conducting polymer 32 can be performed by conventional laser treatment or by local heat treatment.

As an example that is not represented, an Excimer laser emitting at a wavelength of 248 nm, with a pulse of 450 mJ/cm², can be used to locally perform in-depth degradation of the —SO₃H functions of a Nafion® conducting polymer layer 32 having a thickness comprised between 10 μm and 200 μm, in —SO₃H form. Degradation is localized at the level of predefined areas 33 of the Nafion® conducting polymer 32 in —SO₃H form.

The resolution r₂ obtained is about 10 μm. This particular embodiment can preferably be used for an individual cell 9 the active surface of which is larger than or equal to 100 mm².

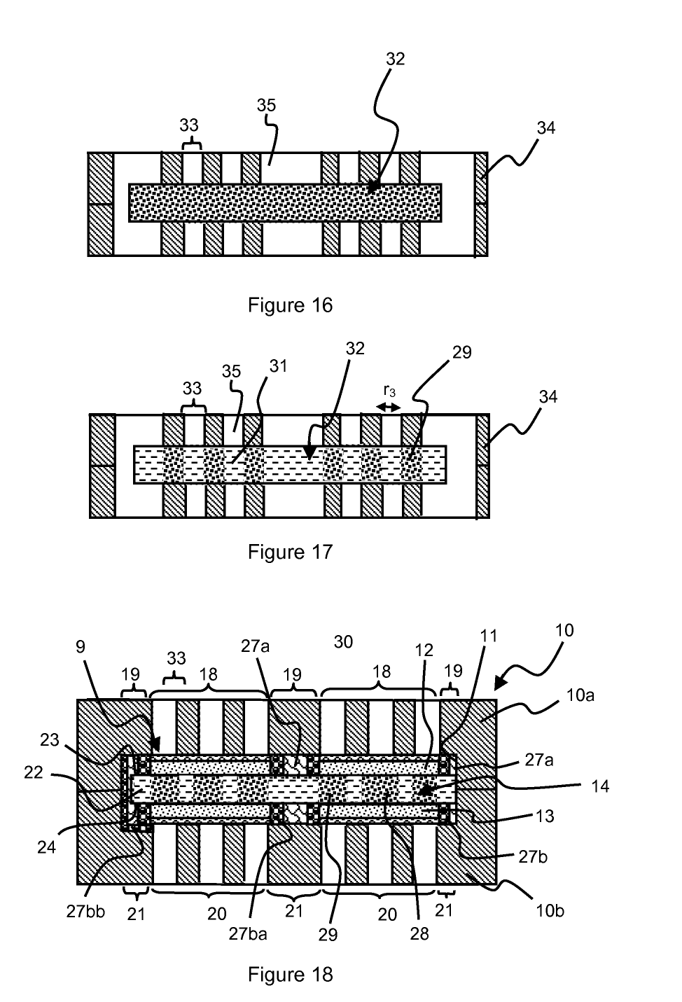

According to an alternative embodiment represented in FIGS. 16 and 17, the membrane 14 is initially constituted by an ionically conducting polymer 32 having sulfonic acid functions. The first and second inactive areas 23 and 24, i.e. the ionically non-conducting part 22 and, possibly, the additional non-conducting part 28, can be achieved by creating ionically non-conducting areas 31 by chemical conversion of the sulfonic acid —SO₃H functions of predefined areas 33 of the ionically conducting polymer 32 into sulfonyl halide —SOₙX functions.

As represented in FIG. 16, a layer of Nafion® conducting polymer 32 in —SO₃H form is imprisoned in a press 34 so as to form a press/membrane assembly. The press 34 is provided with openings 35 enabling predefined areas 33 of the ionically conducting polymer 32 to be exposed.

Conversion consists in treating only the predefined areas 33 of the Nafion® conducting polymer 32 in —SO₃H form by chemical treatment. This step consists in immersing the press/membrane assembly successively in a first solution of soda and then in a chemical etching solution. This chemical etching solution is formed by a mixture advantageously containing the same weight of phosphorus pentachloride PCl₅ in powder form, and of phosphoryl trichloride POCl₃ in liquid form. The press/membrane assembly is then heated for several hours in the PCl₅/POCl₃ solution to a temperature comprised between 100° C. and 130° C., preferably to 120° C., and then rinsed with POCl₃ and/or CCl₄ to eliminate the excess of PCl₅.

The —SO₃H acid functions of the Nafion® conducting polymer 32 are then mechanically converted into sodium sulfonate, —SO₃Na, and then into sulfonyl chloride, —SO₂Cl. The —SO₃H functions are thereby neutralized. The areas hydrolyzed in this way are no longer ionically conducting as the sulfonyl chloride function cannot perform transfer of protons within the membrane 14.

As represented in FIG. 17, the parts protected by the press 34 then form the ionically conducting areas 29 of the membrane 14 and the exposed parts form the ionically non-conducting areas 31 corresponding, according to the selected predefined areas 33, to the ionically non-conducting part 22 and the additional non-conducting part 28 of the finalized membrane 14. The press 34 enables negative masking to be performed with respect to the cover 10.

The resolution r₃ obtained is about 0.1 mm. This particular embodiment can preferably be used for an individual cell 9 the active surface of which is greater than or equal to 1 cm².

The membrane 14 then presents the required ionic conduction characteristics to produce an individual cell 9 having an improved mechanical strength, by means of the method described in the foregoing.

As previously, the cover 10 is then arranged in such a way that it envelops the individual cell 9 and that the openings 25 preferably expose the ionically conducting areas 29 without exposing the ionically non-conducting areas 31.

According to another particular embodiment represented in FIGS. 18 to 20, the fuel cell comprises several coplanar individual cells 9 connected in series and enclosed in the cover 10.

Such a multi-cell fuel cell can be produced by means of identical methods to those described in the foregoing with the exception of the fact that the cover 10 envelops all the individual cells 9.

Furthermore, the predefined areas 33 have to be chosen taking account of the number and the position of the different individual cells 9 of the fuel cell.

Furthermore, as represented in FIG. 18, the fuel cell advantageously has an architecture of “slide” type in which the individual cells 9 have a same membrane 14 that is common to all of the cells 9.

The membrane 14 comprises at least an ionically non-conducting part 22 delineating each cell 9 and extending from the first inactive area 23 to the second inactive area 24, over the whole thickness of the membrane 14 (FIG. 18).

The adhesion means 27 are preferably formed by an adhesive material enabling the cover 10 to be securedly affixed to the individual cells 9 and an electrically conducting material performing electric connection of the individual cells 9 and serial connection of the latter.

The adhesion means 27 are arranged at least at the level of the first and second inactive areas, 23 and 24, between the inner wall 11 and membrane 14.

The adhesion means 27 can advantageously form conducting tracks for performing series connection of the cells 9 of the fuel cell.

As represented in FIG. 18, the adhesion means 27 are formed by two distinct elements respectively constituted by the adhesive material 27a and by the electrically conducting material 27b.

The conducting tracks are advantageously made from an electrically conducting material 27b and formed by a first conducting track 27ba and a second conducting track 27bb.

The first conducting track 27ba surrounds each of the first and second electrodes 12 and 13, and is in direct contact with the side walls of the first and second electrodes 12 and 13.

The second conducting track 27bb is connected to the first conducting track 27ba and connects the first electrode 12 of an individual cell 9 to the second electrode 13 of an adjacent individual cell 9.

The adhesive material 27a can advantageously be arranged on the first and second uncovered parts 19 and 21, which are not used by the conducting tracks 27ba and 27bb.

The first and second conducting tracks 27ba and 27bb can be directly integrated in the first and second covers, respectively 10a and 10b, by means of any known method. The first and second tracks 27ba and 27bb can for example be deposited by physical vapour deposition or chemical vapour deposition, respectively referred to by the abbreviations PVD or CVD, or by electrodeposition of the electrically conducting material 27b on the inner wall 11 of the cover 10.

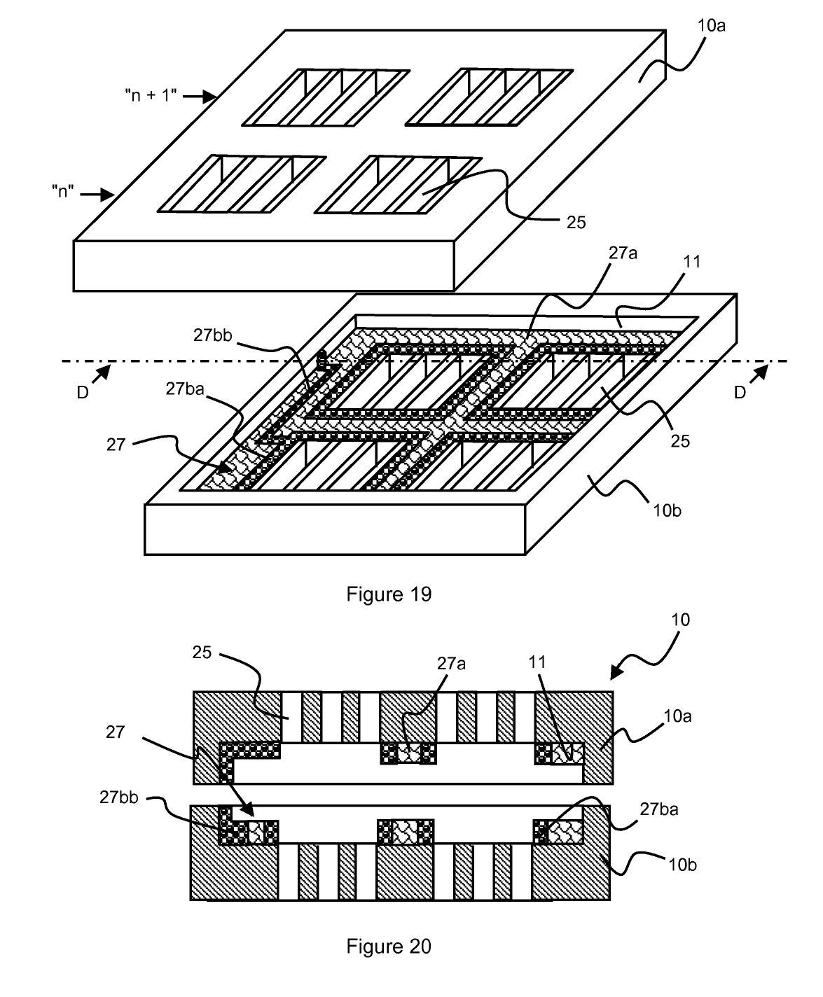

To illustrate this particular embodiment, FIGS. 19 and 20 represent an open cover without the individual cells 9 of a fuel cell according to FIG. 18. The second track 27bb is deposited in such a way as to enable a contact connection between the first electrode 12 of an individual cell 9 in position “n” and the second electrode 13 of an individual cell 9 in the adjacent position “n+1”.

As represented in FIGS. 19 and 20, the second track 27bb starts from the first track 27ba designed to be in contact with the second electrode 13 of the individual cell 9 in position “n”, and is extended along the inner wall 11 of the second cover 10b towards the first cover 10a up to the first track 27ba designed to be in contact with the first electrode 12 of the individual cell 9 in the adjacent position “n+1”. According to this embodiment, the adhesion means 27 improve the mechanical strength of the fuel cell and the adhesive material 27a further prevents corrosion of the electrically conducting material 27b forming the conducting tracks 27ba and 27bb.

According to an alternative embodiment that is not represented, the adhesion means 27 are formed by a material having both adhesive properties and electric conduction properties. The adhesion means 27 can for example be formed by a glue having an epoxy, silicone or polyurethane base containing an electrically conducting material, for example a metallic material. The adhesion means 27 are arranged in such a way as to form only conducting tracks ensuring both electric conduction and adhesion of the individual cells 9 to the cover wall 10.

A fuel cell according to the invention presents the advantage of being easy and quick to implement, while at the same time enabling high power densities to be achieved. Furthermore, the fuel cell presents a very good mechanical strength, as well as a good tightness significantly improving the resistance of the cell to ageing.

1. A fuel cell comprising:
at least one individual cell including:
a membrane having
first and second main surfaces,
a first region made from a first polymer material,
a second region made from a second polymer material obtained by modification of functional groups of the first polymer material, wherein one of the first and second regions is configured to form a polymer electrolyte, the other of the first and second regions is configured to he electrically and ionically non-conducting so as to form a first inactive area,
a first electrode covering the first main surface so as to define in the polymer a first covered part covered by the first electrode and a first non-covered part not covered by the first electrode, the first non-covered part facing the first inactive area,
a second electrode, covering the second main surface so as to define in the polymer a second covered part covered by the second electrode and a second non-covered part not covered by the second electrode
and a cover provided with an inner wall housing the at least one individual cell, wherein the inner wall of the cover is mechanically fixed onto at least the first inactive area by a gas-tight adhesive configured so as to fill a space arranged between the inner wall of the cover and the membrane.

2. The fuel cell according to claim 1, wherein the adhesive comprises an adhesive material.

3. The fuel cell according to claim 2, wherein the adhesive material is chosen from cements, soldering materials, adhesive tapes and glues or varnishes having an epoxy, silicone or polyurethane base.

4. The fuel cell according to claim 1, wherein the adhesive comprises an electrically conducting material so as to electrically couple an individual cell to an adjacent individual cell.

5. The fuel cell according to claim 4, wherein the electrically conducting material is chosen from carbon and metals.

6. The fuel cell according to claim 1, wherein the other of the first and second regions extends from the first area to a second inactive area facing the second non-covered part, over the whole thickness of the membrane.

7. The fuel cell according to claim 1 comprising a third region made from the first or the second polymer material and configured to he electrically and ionically non-conducting, said third region forming a network of inactive areas within the membrane.

8. The fuel cell according to claim 1 comprising several coplanar individual cells connected in series and enclosed in the cover, said individual cells having the same membrane common to all of said individual cells, the membrane comprising at least one area being electrically and ionically non-conducting and defining each individual cell and extending from the first inactive area to a second inactive area facing the second non-covered part, over the whole thickness of the membrane.

9. The fuel cell according to claim 8, wherein the adhesive comprises conducting tracks formed by:
a first track surrounding each of the first and second electrodes and in direct contact with the side walls of said first and second electrodes and,
a second track connected to the first track and connecting the first electrode of one of the individual cell to the second electrode of an adjacent individual cell.

10. A fabrication method of a fuel cell according to claim 1, comprising the following steps:
formation of the first and second inactive areas respectively on first and second main surfaces of a membrane formed by an ionically conducting polymer electrolyte, and
fixing of a cover onto said membrane by adhesive placed between the first inactive area and the inner wall of the cover and/or the second inactive area and the inner wall of the cover.

11. The method according to claim 10, wherein the membrane is initially formed by an ionically non-conducting polymer having sulfonyl halide functions, the first and second inactive areas are achieved by forming ionically conducting areas by hydrolysis of the sulfonyl halide functions of predefined areas of said polymer.

12. The method according to claim 10, wherein the membrane is initially formed by an ionically conducting polymer having sulfonic acid functions, the first and second inactive areas are achieved by forming ionically non-conducting areas, by degradation of the sulfonic acid functions of predefined areas of said polymer.

13. The method according to claim 10, wherein the membrane is initially formed by an ionically conducting polymer having sulfonic acid functions, the first and second inactive areas are achieved by creating ionically non-conducting areas by chemical conversion of the sulfonic acid functions of predefined areas of said polymer into sulfonyl halide functions.

14. The fuel cell according to claim 5, wherein the metals are selected from the group consisting of gold, silver, copper, nickel, aluminum and their alloys.
